(19) United States
(12) Patent Application Publication
(10) Pub. No.: US 2007/0102048 A1
(43) Pub. Date: May 10, 2007

(54) BLOCK COAXIAL VALVE FOR USE IN COMPRESSED AIR SYSTEMS

(76) Inventor: Tiziano Bravo, Villa Carcina (BS) (IT)

Correspondence Address: MCGLEW & TUTTLE, PC, P.O. BOX 9227, SCARBOROUGH STATION, SCARBOROUGH, NY, 10510-9227, US

(21) Appl. No.: 11/531,040

(22) Filed: Sep. 12, 2006

(30) Foreign Application Priority Data
Nov. 7, 2005 (IT) BS2005U000032

(51) Int. Cl. F16K 31/14

(52) U.S. Cl. 137/495

(57) ABSTRACT

The invention concerns a block coaxial valve, especially for compressed air systems. The valve includes a valve body having an aligned fluid input and output ports and, between the ports, a central chamber in which an block piston is housed, functioning as a shutter, formed with an axial hole and movable from a closed position to an opening position of a valve seat provided in the valve body on the side of the fluid input port. The valve body is made up of an intermediate tubular element (13) and two couplings sleeves (14, 15) fixed at its opposite far ends. Within the valve body, the intermediate tubular element forms the chamber (18, 18′) housing the piston/shutter (12) whereas the couplings sleeves respectively form the fluid input (16) and output (17) ports.

### FIELD OF THE INVENTION

This invention belongs to the field of the valves for the control of the delivery of fluids, and in particular it relates to a block coaxial valve to be used in compressed air systems.

### PRIOR ART

The pneumatic block coaxial valves herein taken into consideration are the so-called full flow automatic valves. They can either be simple or double effect valves, normally closed or open.

Usually, these valves include a valve body with an aligned fluid input and output ports and, between said ports, a coaxial chamber in which a block piston is housed, functioning as a shutter, having an axial hole and movable between a closed position and opening position of a valve seat formed in the valve body on the side of the fluid input port.

For its movements between one position and the other, the piston can be piloted by supplying to the chamber an additional fluid flow fed from the external of the valve, or a part of the same fluid flow to be delivered taken upstream the valve seat. If the block piston is a simple effect one, the piloting fluid is supplied to the chamber from one side of the piston, opposite to a spring operating from the opposite side of the piston, whereas if the piston is a double effect one, the control fluid is loaded/unloaded from both sides of the piston in turns, depending of its direction of movement.

However, the currently known coaxial block valves, not only are voluminous and consequently bulky, but they are also relatively complex both in terms of body, size and the piston control system. In fact, the valve body e is usually produced by casting and subsequently machined, and the piston has two opposite stems that require a double control and sealing system within the body of the valve.

### OBJECT OF THE INVENTION

However, it is an objective of this invention to provide a coaxial valve especially, but not only, for use in compressed air systems, that are easier to produce both technically and economically, valves of smaller dimensions lengthwise and with the advantage of having an intermediate part of the body simply made of a tubular element and a short piston having a sliding and sealing system only on one side.

This objective and said advantages are achieved with a coaxial valve basically in accordance with the claim 1 to follow.

### BRIEF DESCRIPTION OF THE DRAWINGS

The invention will however be described in more details further ahead with reference to the enclosed drawings, in which:

FIG. 1 is a longitudinal cross-section of the valve when closed;

FIG. 2 is a similar section of the valve when opened; and

FIG. 3 is a section of the valve as assembled.

### DETAILED DESCRIPTION OF THE INVENTION

As illustrated, the valve is basically made up of a valve body 11 and a piston 12 functioning as a shutter. The valve body 11 is made up of an intermediate tubular element 13 and two coupling sleeves 14 and 15 positioned on its two opposite ends. The intermediate element 13 can profitably be obtained from a pipe, preferably made of aluminium. The coupling sleeve 14 and 15 are screwed to the ends of said tubular element 13 and they can also be made of aluminium, for example obtained through die-casting.

The valve body 11 thus made has a fluid input port 16 formed by a first coupling sleeve 14 on an end, a liquid output port 17 formed by the opposite coupling sleeve 15 on the other end. Between the input and output ports, there is a central chamber in which the piston 12 is housed, dividing it into a first compartment 18, upstream, on the side of the first coupling sleeve and a second compartment 18′, downstream, on the side of the second coupling sleeve.

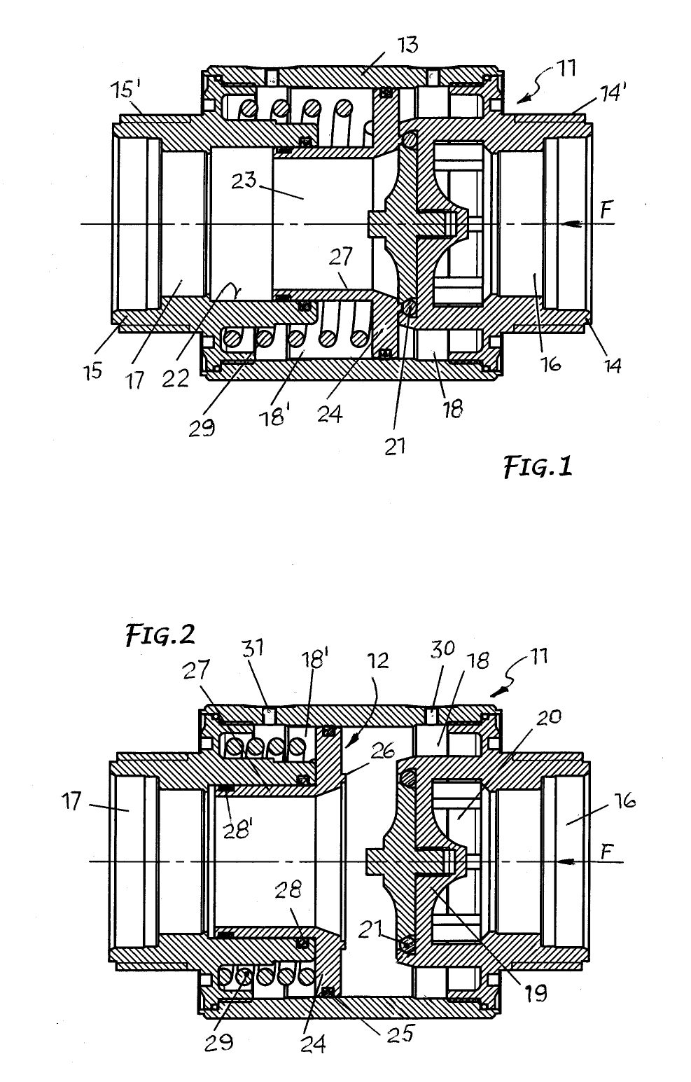

Each coupling sleeves 14, 15 has a threaded part 14′, 15′ or could be equipped with a quick coupling on which fluid circulation pipes my to be connected, compressed air in this case, to be supplied flowing towards the direction indicated by arrow F in FIGS. 1 and 2.

Facing the input port 16, between the latter and the piston 12, in the first coupling sleeve 14, a deflector unit 19 around which radial apertures 20 are formed to connect the input port with the first central chamber compartment 18.

On its surface facing the piston 12, the deflector unit 19 forms a valve seat 21 with a relative gasket.

In one part of the second coupling sleeve 15, which forms the output port 17, a guide seat 22 is obtained.

The piston 12 can be obtained from an aluminium bar, it is formed with a through axial hole 23 and it has a flange 24 around which at least one sealing gasket 25 is mounted to operate on the internal surface of the chamber in which the piston moves.

On a surface of the flange 24, around a mouth of the axial hole 23, on the side facing the first compartment 18, an annular protrusion 26 is obtained facing the seat 21 to interact with the latter.

On the opposite surface of said flange 24, there is an extending guide stem 27 which houses and moves in the guide seat 22 formed by the second coupling sleeve, with the interposition of a sealing gasket 28 and a sliding pad 28′. Therefore, the piston is held and guided only on one side, that is on the side of its stem 27 that is coupled with the guide pad 22 in the second coupling sleeve through the sealing gasket 28 and the sliding pad 28.

The piston 12 is movable between a closed and opening positions of the valve, in one direction by means of a spring 29 and towards the opposite direction by means of a piloting fluid under pressure, that gets to the first compartment 18 of the central chamber facing the piston, through the radial apertures 20 of the first coupling sleeve 14.

In the intermediate tubular element 13 there are formed a radial hole 30 communicating with the first compartment 18 and another radial hole 31 communicating with the second compartment 18′ on the opposite sides of the piston.

In the example shown in the drawings, the spring 29 is positioned and placed behind the flange 24 of the piston, between this flange and the second coupling sleeve 15. The spring is basically concentric to the guide stem 27 and usually maintains the piston advanced in the closed position on the valve seat 21, thus avoiding the delivery of fluid—FIG. 1.

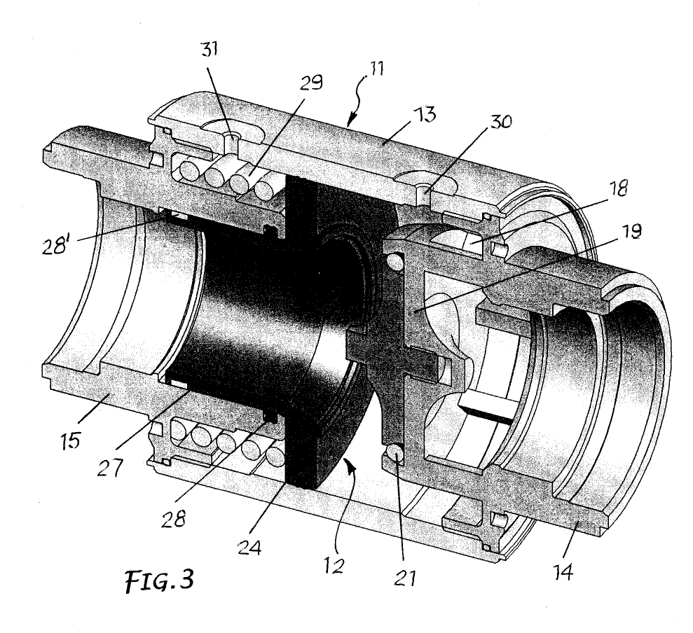

The valve is opened by supplying a piloting fluid into the first compartment 18 of the central chamber, in opposition to the action of the spring 29, in a way to move the piston 12 backwards, that is away from the valve seat 21, thus allowing the flow of the fluid to be delivered from the input port 16 to the output port 17 through the radial apertures 20 in the first coupling sleeve and the axial hole 23 of the piston—FIGS. 2 and 3.

Profitably and corresponding to the example of the valve illustrated in the drawings, as piloting fluid for the piston it is used the same conduit fluid that flows from the input port 16 into the first compartment 18 facing the piston 12, through the radial apertures 20 of the first coupling sleeve 14.

Basically, when the piston 12, pushed by the spring 29, is in the closed position against the seat 21, the fluid, the compressed air, that gets into the input port 16 flows into the first compartment 18, and also into the radial hole 30, working on the piston with a force contrasted by the spring and which is equal to the conduit pressure by the surface of the piston flange exposed to the fluid. When said force exceeds the force of the spring 29, the piston 12 retreats, opening the passage of the fluid from inlet port 16 to the output port 17.

Likewise, the fluid under pressure, through the hole 30, gets to an electric or manual valve—not illustrated—by which the conduit pressure may be directed to the balancing hole 31 and, through this, to the second compartment 18′ to the back of the piston. Until this does not take place, the valve is kept open to allow the delivery of the fluid. Instead, when a controlled delivery of fluid under pressure is supplied to the chamber 18′ at the back of the piston, the pressure on the two opposite sides of the flange of the piston is balanced, so the spring 29 moves the piston toward the closed position against the valve seat 21.

Given that the pressure from both sides of the flange is balanced, the time and force for closing the piston shall always be the same and independent from the amount of conduit pressure.

1. Block coaxial valve, in particular for compressed air systems, including a valve body having an aligned fluid input and output ports and between said ports, a central chamber in which an block piston is housed acting as a shutter, formed with an axial hole and movable from a closed position to an opening position of a valve seat provided in the valve body on the side of the fluid input port, characterized in that the valve body is composed of an intermediate tubular element and two coupling sleeves set at opposite ends of the tubular element, and in that said intermediate tubular element forms the central chamber housing said piston/shutter and said coupling sleeves respectively define the fluid input and output ports.

2. Coaxial valve according to claim 1, wherein said piston/shutter divides said central chamber into a first compartment, upstream, on the side of the coupling sleeve defining the input port and a second compartment, downstream, on the side of the coupling sleeve defining the output port, wherein in said coupling sleeve defining the input port a deflector unit is formed and around which radial openings are provided to connect said input port with said first compartment of the central chamber when the piston/shutter is in the opening position, wherein the seat valve is provided on a surface of said deflector unit faces the piston/shutter, and wherein the coupling sleeve defining the output port outlines a guide seat to guide the piston/shutter.

3. Coaxial valve according to claim 1, wherein the piston/shutter has a head flange with at least one sealing gasket acting on an internal surface of the central chamber in which the piston moves, an annular protrusion on the front surface of said head flange facing, and designed to interact with, said valve seat and a guide stem extending from an opposite surface of said head flange and coupled with the guide seat of the coupling sleeve defining the output port.

4. Coaxial valve according to claim 3, wherein the piston/shutter is held and guides only in the guide seat of the coupling sleeve defining the output port with the interposition of at least one sealing gasket and a sliding pad.

5. Coaxial valve according to claim 1, wherein the intermediate tubular element of the valve body is formed by a pipe, preferably made of aluminum, and each coupling sleeve is preferably of die-cast aluminum.

6. Coaxial valve according to claim 1, wherein a spring is provided to d maintain the piston/shutter in the closed position, while the piston/shutter is shifted to the opening position by the fluid under pressure passing through the first compartment and acting directly on the piston/shutter in opposition to said spring.

7. Coaxial valve according to claim 6, wherein when the piston/shutter in the closed position against the valve seat, the compartment upstream the piston communicates with the input port and to a radial hole formed on the intermediate tubular element, the entry of fluid under pressure causing the piston/shutter to shift to the opening position, and wherein said radial hole is connected to a piloting valve allowing a controlled input of the fluid under pressure even in the compartment downstream the piston through radial balancing hole for a piloted return of the piston back to the closure position with the help of said spring.

8. Coaxial valve according to claim 2, wherein the piston/shutter has a head flange with at least one sealing gasket acting on an internal surface of the central chamber in which the piston moves, an annular protrusion on the front surface of said head flange facing, and designed to interact with, said valve seat, and a guide stem, extending from an opposite surface of said head flange and coupled with the guide seat of the coupling sleeve defining the output port.
